(19) United States
(12) Patent Application Publication
(10) Pub. No.: US 2026/0208308 A1
(43) Pub. Date: Jul. 23, 2026

(54) ROUTER JIG

(71) Applicant: Hui Chuan Liao, Oakland, CA (US)

(72) Inventors: Hui Chuan LIAO, Oakland, CA (US); Yu-Chen HSIAO, Taichung City (TW); Yin-Liang LIAO, Taichung City (TW)

(21) Appl. No.: 19/033,735

(22) Filed: Jan. 22, 2025

(51) Int. Cl. B23Q 9/00; B27C 5/10

(52) U.S. Cl. CPC B23Q 9/0028; B27C 5/10

(57) ABSTRACT

A router jig includes a jig base with a jig base plate having a top surface configured to connect to a router and from which extends a spacer shield, an adaptor fence, which is removably fastened to the jig base plate, and which is linearly movable with respect to the jig base plate, the adaptor fence including a horizontal plate and a vertical wall, the vertical wall including a stable surface that contacts the straight edge tool and a front face on an opposite side of the vertical wall as the stable surface. The router jig also includes a rail fence which is removably fastened to the adaptor fence, which is linearly movable with respect to the adaptor fence, and which is rotatable relative to the adaptor fence, the rail fence including a horizontal surface and a vertical guide bar disposed at an end of the horizontal surface.

### BACKGROUND

The present invention relates to router jigs, and more specifically to router jigs used in conjunction with straightedge tools.

Routers are power tools with a flat base and a rotating blade or bit extending past the base. A spindle which is connected to the rotating blade or bit is typically driven by an electric motor or by a pneumatic motor. By action of the rotating blade, the router removes material from a hard surface, such as wood or plastic. Routers are used most often in woodworking, especially cabinetry. When woodworking, a dado cut is a hollow space cut into a surface of the wood formed in a direction against the grain of the wood.

Often, a straightedge tool is employed when using a router to improve the quality of the cut. Additionally, a router jig is typically used in conjunction with the straightedge tool. A router jig is a device that guides the router to cut or shape the hard surface, allowing a user of the router and router jig to create a template or guide. The router jig is typically secured or attached to the straight edge tool to improve the accuracy of the cut from the router.

Existing router jigs provide insufficient flexibility with regard to the type of straightedge tool which optionally is used with the router jig. Accordingly, there exists a need for an improved router jig.

### SUMMARY

The above-listed need is met or exceeded by the present router jig. In particular, the present router jig includes a router jig base, an adaptor fence, and a rail fence, where the adaptor fence includes a stable surface which contacts one side of a straightedge tool, and the fail fence includes at least one contact surface which contacts another side of the straightedge tool. Specifically, the rail fence is rotatable relative to the adaptor fence between a first position and a second position, and the rail fence preferably includes a vertical guide bar with first and second contact surfaces. Preferably, rotation of the rail fence to the first position aligns the vertical guide bar so that the first contact surface faces the stable surface, which defines a first distance between the first contact surface and the stable surface. Similarly, when the rail fence is in the second position, the second contact surface faces the stable surface, defining a second distance between the second surface and the stable surface. Moreover, regardless of whether the rail fence is in the first position, or the second position, the rail fence is linearly movable with respect to the adaptor fence, which helps allow for use of a greater range of straightedge tools with the present router jig.

In an embodiment, the router jig base and the adaptor fence both include surfaces which engage a spacer shield that is placed between the adaptor fence and the router jig base. Moreover, in this embodiment, the router jig base and the adaptor fence are linearly movable with respect to one another, which helps allow spacer shields of various thicknesses to be used with the present router jig. Further, the present router jig preferably includes a cutting mark on a surface of the router jig base which preferably guides the router jig, and shows where a cut mark from the router jig will be formed.

More specifically, a router jig configured to be secured to a straight edge tool, includes a jig base with a jig base plate having a top surface configured to connect to a router and from which extends a spacer shield, an adaptor fence, which is removably fastened to the jig base plate, and which is linearly movable with respect to the jig base plate, the adaptor fence including a horizontal plate and a vertical wall, the vertical wall including a stable surface that contacts the straight edge tool and a front face on an opposite side of the vertical wall as the stable surface. The router jig also includes a rail fence which is removably fastened to the adaptor fence, which is linearly movable with respect to the adaptor fence, and which is rotatable relative to the adaptor fence, the rail fence including a horizontal surface and a vertical guide bar disposed at an end of the horizontal surface.

Additionally, the vertical guide bar has a first contacting surface which defines a first distance between the first contacting surface and the stable surface when the rail fence is rotated such that the first contacting surface faces the stable surface, and a second contacting surface on an opposite side of the vertical guide bar as the first contacting surface, the second contacting surface defining a second distance between the second contacting surface and the stable surface when the rail fence is rotated such that the second contacting surface faces the stable surface.

In a preferred embodiment, the router jig includes a cutting mark disposed on a leading edge of the jig base plate, such that the cutting mark including a center mark, a right side toolpath mark, and a left side toolpath mark, which are aligned with a left edge and a right edge, respectively, of a toolpath generated by the router. Preferably still, the right side toolpath mark and the left side toolpath mark each include a plurality of steps corresponding to different diameter router bits of the router.

In another preferred embodiment, the jig base plate further includes at least one adjustment knob, such that fastening the adjustment knob fixes a relative linear position of the jig base plate and the adaptor fence; and at least one limit setting knob which sets a limit on the relative linear motion between the jig base plate and the adaptor fence. Preferably, the adaptor fence further includes at least one adjustment knob, such that fastening the adjustment knob fixes a relative linear position of the adaptor fence and the rail fence. Preferably still, the adaptor fence and the rail fence each include at least one guide hole through which the at least one adjustment knob is disposed.

In preferred embodiments, the first distance is greater than the second distance and the front face of the vertical wall includes a plurality of steps which define different distances between the steps of the front face and the spacer shield.

In yet another preferred embodiment, the adaptor fence includes a plurality of grooves which mate with a corresponding ridge on the jig base plate, such that when the ridge engages one of the plurality of grooves, a relative position of the adaptor fence and the jig base plate is fixed. Preferably, the plurality of grooves are disposed on a leg of the adaptor fence and are vertically oriented and the ridge of the jig base plate is disposed upon a lip which extends from the jig base plate, such that the ridge is directed toward a center line of the jig base. Preferably still, the jig base plate also includes at least one limit setting knob which sets a limit on the relative linear motion between the jig base plate and the adaptor fence.

In still another preferred embodiment, the adaptor fence includes a plurality of notches which mate with a corresponding clip on the rail fence, such that when the clip engages one of the plurality of notches, a relative position of the adaptor fence and the rail fence is fixed. Preferably, the plurality of notices are disposed below the horizontal plate and are vertically oriented, and such that the clip is disposed upon the horizontal surface of the rail fence.

A second embodiment of the present disclosure is a router jig configured to be secured to a straight edge tool which includes a jig base which has a jig base plate having a top surface configured to connect to a router, a vertical plate which extends from the top surface of the jig base plate, the vertical plate including a stable surface that contacts the straight edge tool, and a horizontal plate which is vertically displaced from the jig base plate and which is connected to the vertical plate. The router jig also includes a rail fence which is removably fastened to the horizontal plate, which is linearly movable with respect to the jig base, and which is rotatable relative to the horizontal plate, the rail fence including a horizontal surface and a vertical guide bar disposed at an end of the horizontal surface.

The vertical guide bar includes a first contacting surface which defines a first distance between the first contacting surface and the stable surface when the rail fence is rotated such that the first contacting surface faces the stable surface, and a second contacting surface on an opposite side of the vertical guide bar compared to the first contacting surface, the second contacting surface defining a second distance between the second contacting surface and the stable surface when the rail fence is rotated such that the second contacting surface faces the stable surface.

In a preferred embodiment, the router jig also includes a cutting mark disposed on a leading edge of the jig base plate, the cutting mark including a center mark, a right side toolpath mark, and a left side toolpath mark, which are aligned with a left edge and a right edge, respectively, of a toolpath generated by the router. Preferably, the right side toolpath mark and the left side toolpath mark each include a plurality of steps corresponding to different diameter router bits of the router. Preferably still, the first distance is greater than the second distance.

In yet another preferred embodiment, the adaptor fence also includes at least one adjustment knob, such that fastening the adjustment knob fixes a relative linear position of the adaptor fence and the rail fence. Preferably, the adaptor fence and the rail fence each include at least one guide hole through which the at least one adjustment knob adaptor knob is disposed.

### BRIEF DESCRIPTION OF THE DRAWINGS

FIG. 1 is a top perspective view of a first embodiment of the present router jig;

FIG. 2A is a side elevated view of the router jig shown in FIG. 1;

FIG. 2B is a partial side elevated exploded view of the router jig shown in FIG. 1;

FIG. 2C is a side elevated view of the router jig shown in FIG. 1;

FIG. 3 is a bottom exploded perspective view of the router jig shown in FIG. 1;

FIG. 4A is a top plan view of the router jig shown in FIG. 1;

FIG. 4B is an enlarged partial view of the router jig shown in FIG. 4A;

FIG. 5 is a top perspective view of a second embodiment of the present router jig;

FIG. 6A is a side elevated view of the router jig shown in FIG. 5;

FIG. 6B is a partial side elevated exploded view of the router jig shown in FIG. 5;

FIG. 6C is a side elevated view of the router jig shown in FIG. 5;

FIG. 7 is a bottom exploded perspective view of the router jig shown in FIG. 5;

FIG. 8A is a top plan view of the router jig shown in FIG. 5;

FIG. 8B is an enlarged partial view of the router jig shown in FIG. 8A;

FIG. 9 is a top perspective view of a third embodiment of the present router jig;

FIG. 10A is a side elevated view of the router jig shown in FIG. 9;

FIG. 10B is a partial side elevated exploded view of the router jig shown in FIG. 9;

FIG. 10C is a side elevated view of the router jig shown in FIG. 9;

FIG. 11 is a bottom exploded perspective view of the router jig shown in FIG. 9;

FIG. 12A is a bottom plan view of the router jig shown in FIG. 9;

FIG. 12B is an enlarged partial view of the router jig shown in FIG. 12A;

FIG. 12C is an enlarged partial view of the router jig shown in FIG. 12A; and

FIG. 12D is an enlarged partial view of the router jig shown in FIG. 12C.

### DETAILED DESCRIPTION

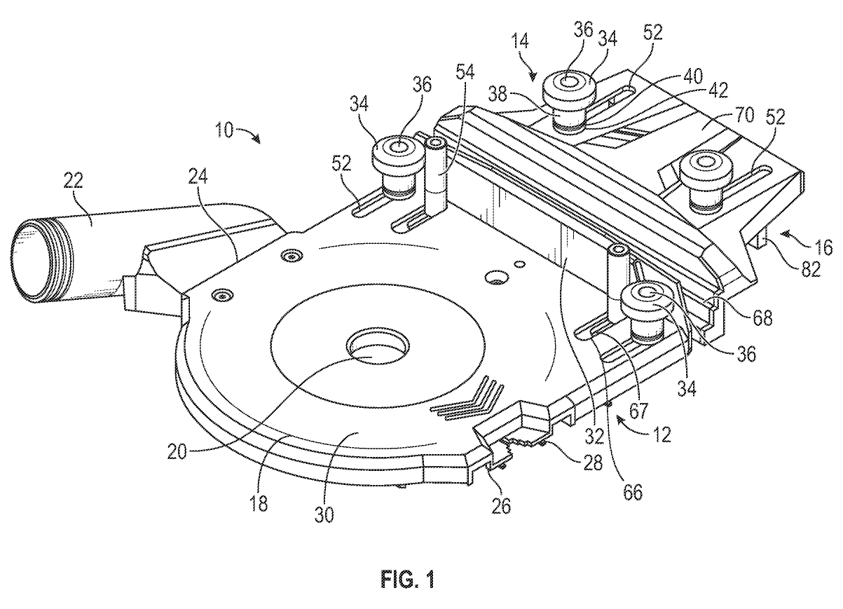

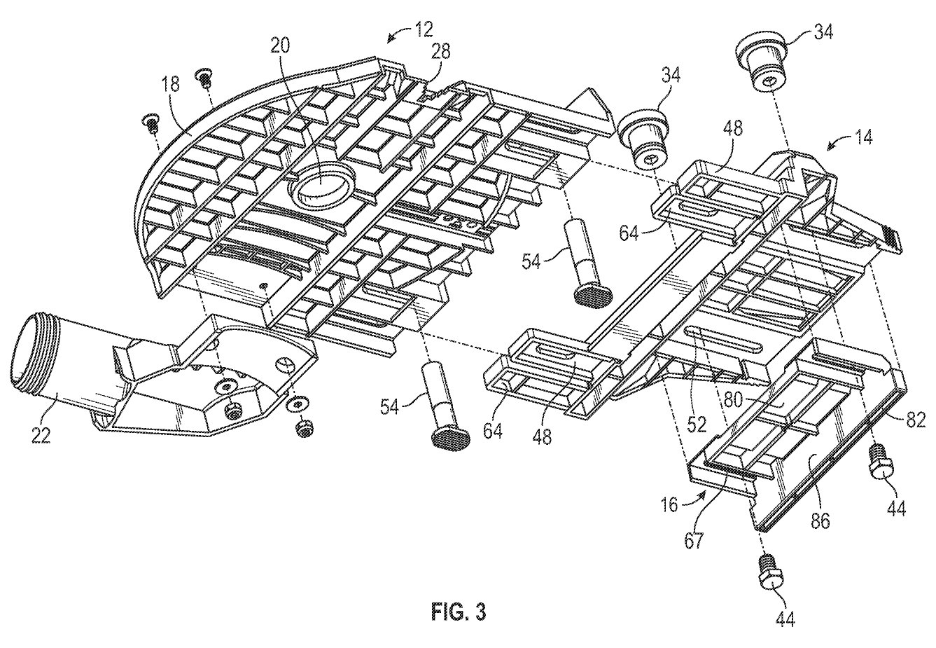

Referring now to FIGS. 1-3, in which the components are shown schematically and not to scale, a first embodiment of the router jig is generally designated 10 and includes a jig base 12, a movable adaptor fence 14, and a movable rail fence 16. The jig base 12 includes a jig base plate 18 with a guide bushing 20 which receives a bit (not shown) from a router (not shown), where the guide bushing is preferably centrally located upon the jig base plate. A dust port 22 is preferably removably secured to the jig base plate 18 on a trailing edge 24 of the jig base plate. Preferably, the dust port 22 is connected to a source of suction (not shown) to remove wood chips produced from operation of the router jig. Additionally, a leading edge 26 of the jig base plate 18 preferably includes a cutting mark 28, which will be described in greater detail below. The guide bushing 20 is optionally an opening within a top surface 30 of the jig base plate 18. A spacer shield 32, which partially retains a spacer (not shown), extends from the top surface 30 of the jig base plate 18 proximate to the movable adaptor fence 14.

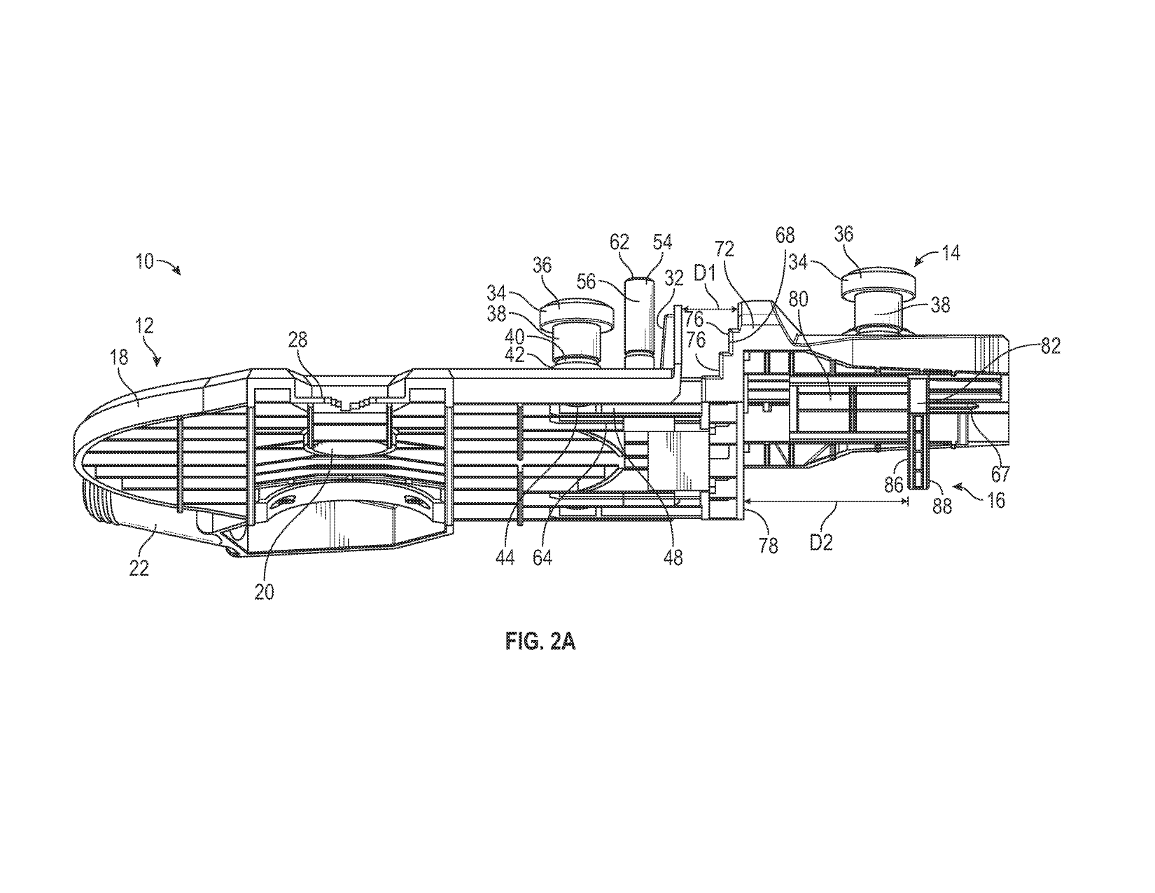

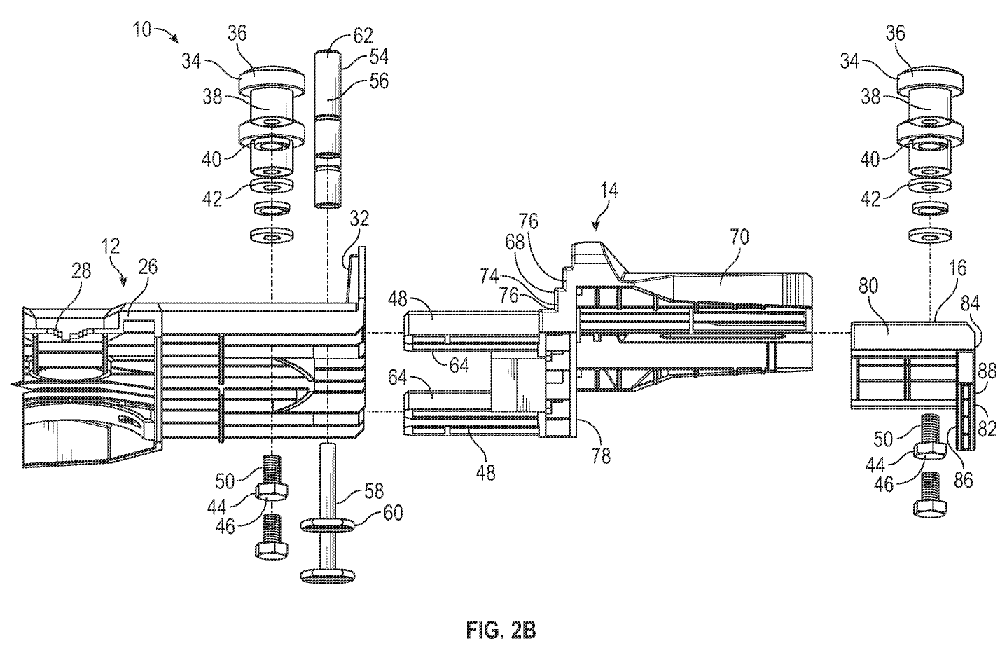

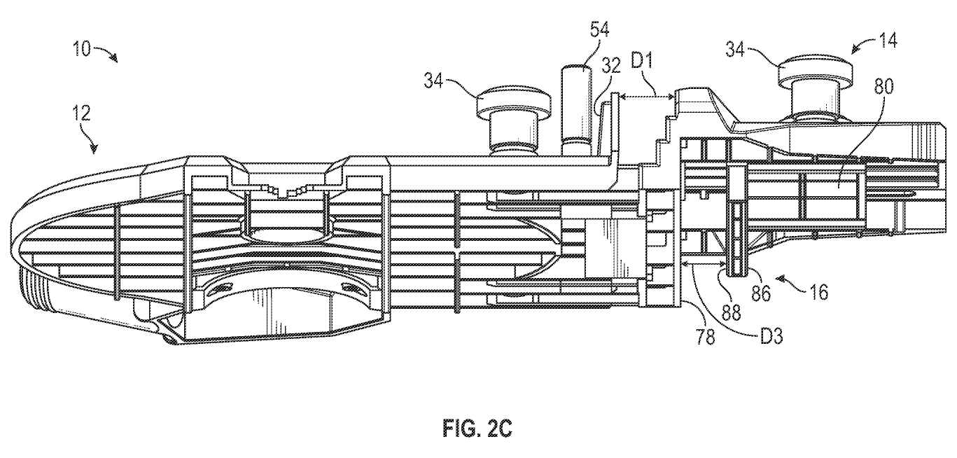

Referring now to FIGS. 1-2C, the movable adaptor fence 14 is removably fastened to the jig base plate 18 via at least one, and preferably two, adjustment knobs 34 which each preferably include a handle 36 with an internal nut 38, a split washer 40, a flat washer 42, and a bolt 44. A head 46 of each of the bolts 44 is in contact with one of two outer legs 48 of the movable adaptor fence 14, and a shaft 50 of each of the bolts 44 threadingly engages the internal nut 38 within the handle 36. In operation, a user of the movable adaptor fence 14 optionally tightens the handle 36 of the adjustment knob 34, thereby compressing the split washer 40 and securing a relative position of the jig base plate 18 and the movable adaptor fence 14. As such, the movable adaptor fence 14 is linearly movable relative to the jig base plate 18 by loosening the adjustment knob 34, such that the split washer 40 is no longer compressed, and the movable adaptor fence is movable relative to the jig base plate. Preferably, the jig base plate 18 includes a guide hole 52 into which the shaft 50 of the bolt 44 is inserted, such that the relative positions of the jig base plate 18 and the movable adaptor fence 14 are preferably limited by the length of the guide hole.

In a preferred embodiment, the jig base 12 also includes at least one, and preferably two, limit setting knobs 54 which limit the relative linear movement between the jig base plate 18 and the movable adaptor fence 14. Specifically, the limit setting knob 54 preferably includes a post 56 disposed above the top surface 30 of the jig base plate 18 which threadingly engages a bolt 58 with a head 60. The post 56 preferably includes a knurled portion 62 which has a diameter greater than a remainder of the post. Preferably, the movable adaptor fence 14 includes at least one inner leg 64 which retains the head 60 of the bolt 58, such that the bolt extends through a limit setting guide hole 66 of the jig base plate 18 and an opening 67 in the inner leg, and threads with the post 56 of the limit setting knob 54.

The limit setting guide hole 66 in the jig base plate 18 and the opening 67 in the inner leg 64 allow adjustment of the relative position of the limit setting knob 54 relative to the adaptor fence 14. In this way, the limit setting knob 54 is preferably set at a specific position, such that even with adjustment of the adjustment knobs 34, a maximum distance between the spacer shield 32 and the adaptor fence 14 is preferably fixed.

Opposite the spacer shield 32, the adaptor fence 14 includes a vertical wall 68 which, together with the spacer shield, retain the spacer. Additionally, the adaptor fence 14 includes a horizontal plate 70, such that the vertical wall 68 extends from an end 72 of the horizontal plate. A front face 74 of the vertical wall 68 facing the spacer shield 32 preferably has at least two steps 76 which define different spacings between the steps of the front face and the spacer shield. As shown in FIG. 2A, the step 76 is a distance D1 from the spacer shield 32.

A stable surface 78 is on an opposite side of the vertical wall 68 compared to the front face 74. As will be discussed in greater detail below, the stable surface 78 helps retain a straightedge tool (not shown) when the router jig 10 is in use.

The movable rail fence 16 is removably fastened to the adaptor fence 14, such that the movable rail fence is linearly movable with respect to the adaptor fence. Specifically, the movable rail fence 16 is preferably secured to the adaptor fence 14 via at least one, and preferably two, of the adjustment knobs 34. Additionally, the adaptor fence 14 includes one of the guide holes 52 for each of the at least one adjustment knobs 34, and the rail fence 16 includes one of the openings 67 for each of the at least one adjustment knobs.

The movable rail fence 16 includes a horizontal surface 80 and a vertical guide bar 82 which is disposed at an end 84 of the horizontal surface. The vertical guide bar 82 includes a first contact surface 86 and a second contact surface 88 disposed on opposite sides of the vertical guide bar. Additionally, the movable rail fence 16 is rotatable relative to the rail fence 14, such that in a first position of the movable rail fence shown in FIG. 2A, the first contact surface 86 faces the stable surface 78 and defines a distance D2 therebetween. Similarly, when the movable rail fence 16 is rotated 180 degrees relative to the rail fence 14, as illustrated in a second position of the movable rail fence shown in FIG. 2C, the second contact surface 88 faces the stable surface 78, and defines a distance D3 therebetween.

A beneficial feature of the present movable rail fence 16, is that, by loosening the adjustment knobs 34 securing the movable rail fence to the adaptor fence 14, a user optionally adjusts the distance D2 as needed. For example, straightedge tools often have different thicknesses, and adjustment of the distance D2 allows the router jig 10 to be operable with a variety of straightedge tools having different thicknesses. This feature is further aided by the ability to rotate the movable rail fence 16, thereby changing whether the first contact surface 86 or the second contact surface 88 faces the stable surface 34. When the straight edge tool has a relatively small thickness, the configuration of the router jig 10 shown in FIG. 2C is preferred, since the second contact surface 88 is proximate the stable surface 34, and the distance D3 is allowed to be relatively small. In contrast, with a thick straight edge tool, the configuration of the router jig 10 shown in FIG. 2A is preferred, as the distance D2 is allowed to be relatively large. This preferably allows considerable versatility with regard to straightedges tools with which the router jig 10 is optionally used.

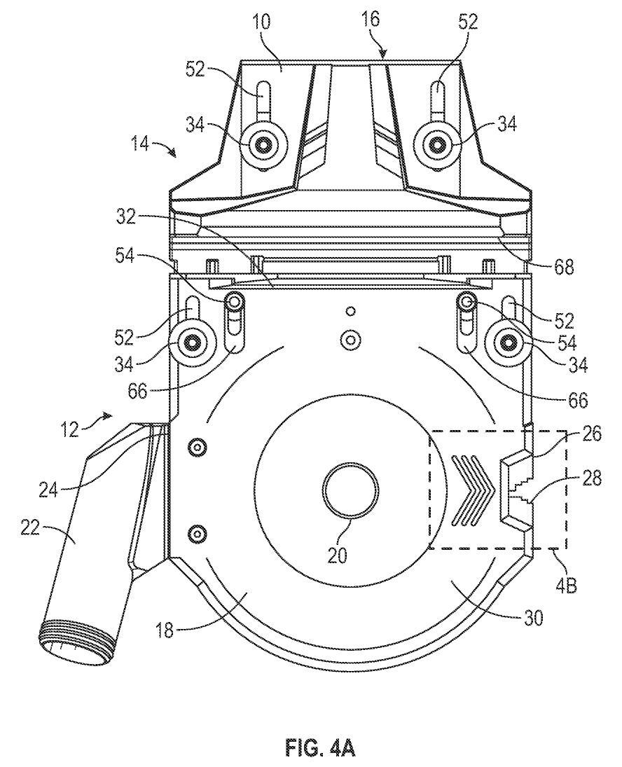

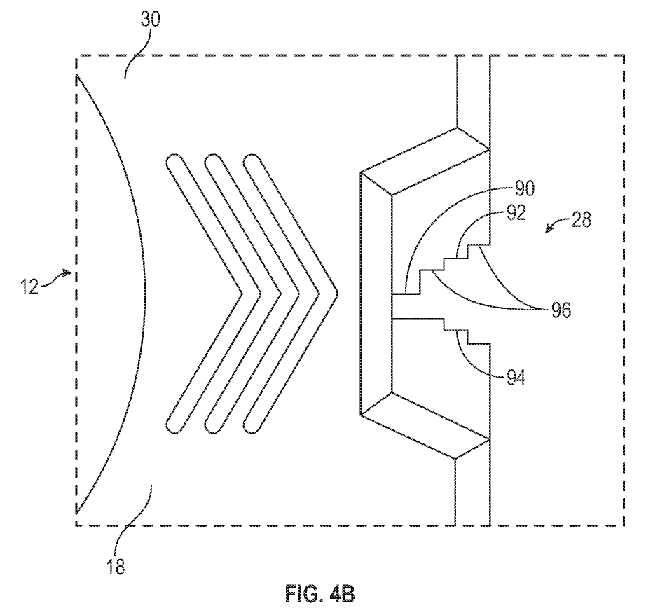

Referring now to FIGS. 4A and 4B, the jig base plate 18 preferably has the cutting mark 30, which includes a center path guide 90 that shows the center line of the router path. The center path guide 90 helps a user of the router jig 10 visualize where the dado made by the router will be loca5ted. A left side toolpath mark 92 is located on a side of the cutting mark 30 proximate to the spacer shield 32 and helps improve alignment of the inner edge of the toolpath of the router. Similarly, a right side toolpath mark 94 is located on a side of the cutting mark 30 opposite to the left side toolpath mark 92, and helps improve alignment of the outer edge of the toolpath of the router. Preferably, the left and right side toolpath marks 92, 94 include at least two steps 96 which are spaced apart from one another by different distances. For example, the first set of steps 96 of the left and right side toolpath marks 92, 94 are spaced apart by one inch, whereas the second set of steps 96 of the inner and outer side toolpath marks are spaced apart by three quarters of an inch. Further, the center path guide 90 preferably is a final step on one of the left and right side toolpath marks 92, 94, which is centrally located between the first set of steps 96 of the left and right side toolpath marks.

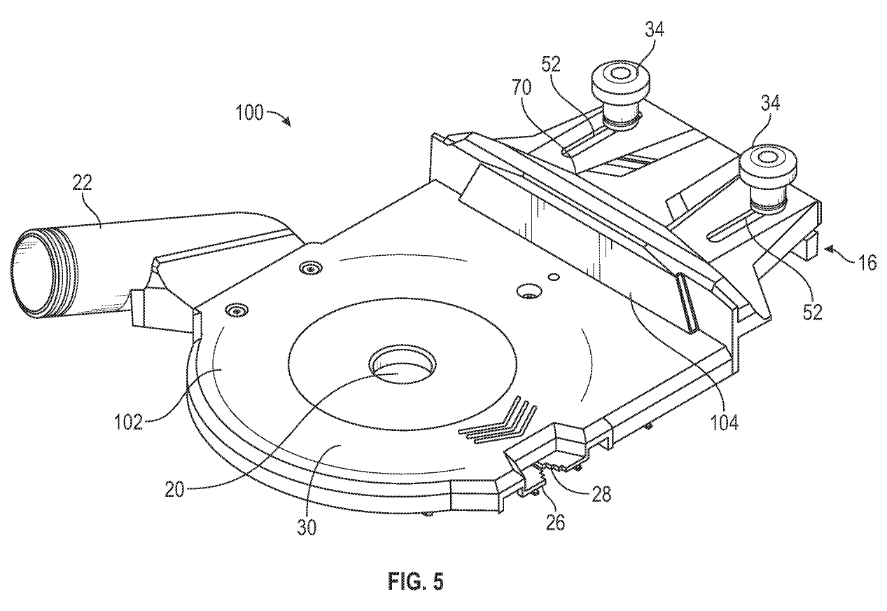

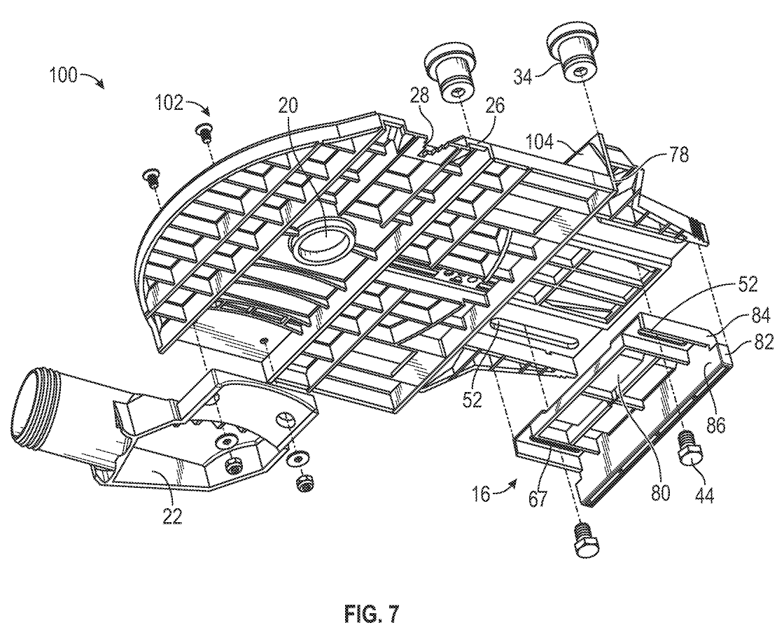

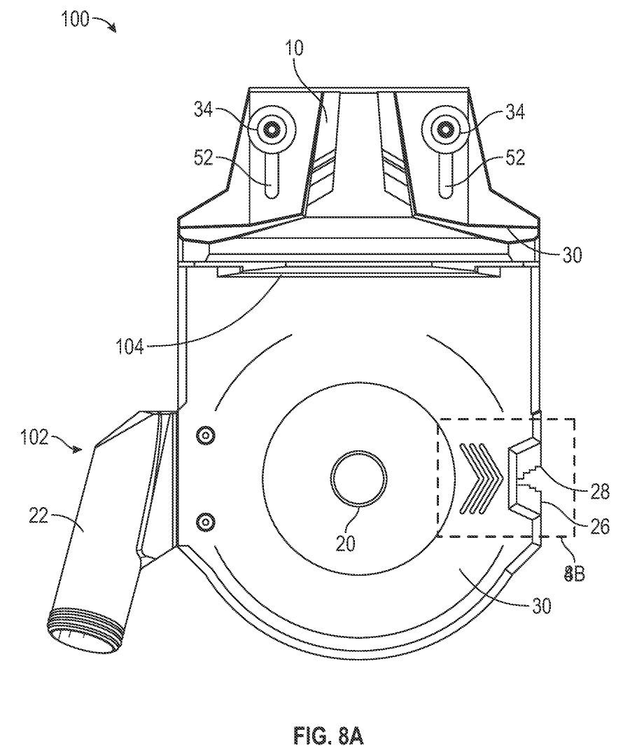

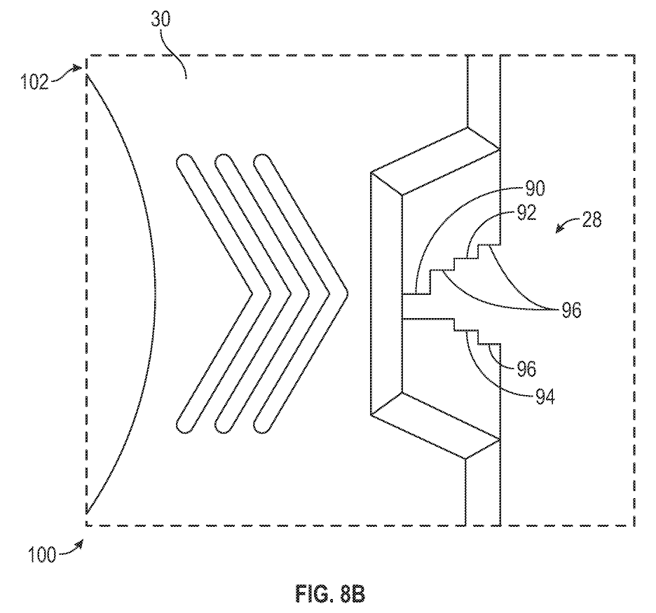

Referring now to FIGS. 5-8B, in which the components are shown schematically and not to scale, a second embodiment of the router jig is generally designated 100. Components which are shared with the first embodiment of the router jig 10 have identical reference numbers. A difference between the first embodiment of the router jig 10 and the second embodiment of the router jig 100, is that the router jig 100 includes a jig base 102 that includes the jig base 12 and the movable adaptor fence 14 in an integral structure. In other words, jig base 102 includes a vertical plate 104 which essentially combines the spacer shield 32 of the jig base 12 with the vertical wall 68 of the movable adaptor fence 14. Accordingly, the router jig 100 omits the adjustment knobs 34 and limit setting knobs 54 which secured the jig base 12 to the movable adaptor fence 14.

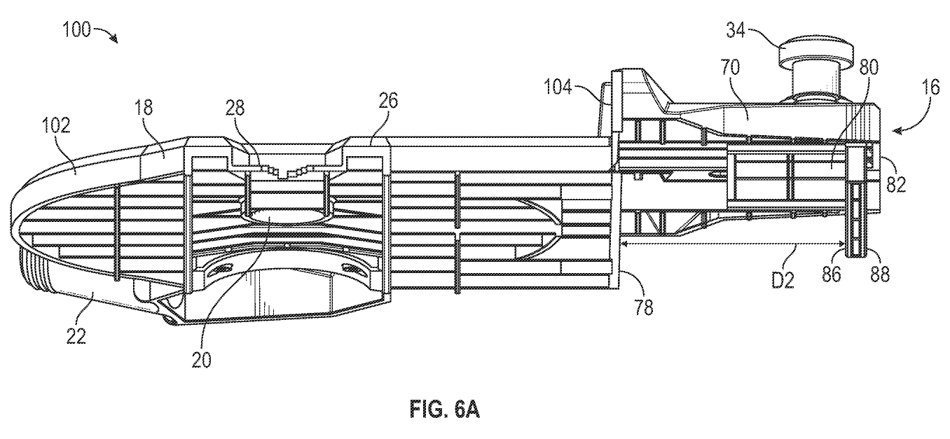

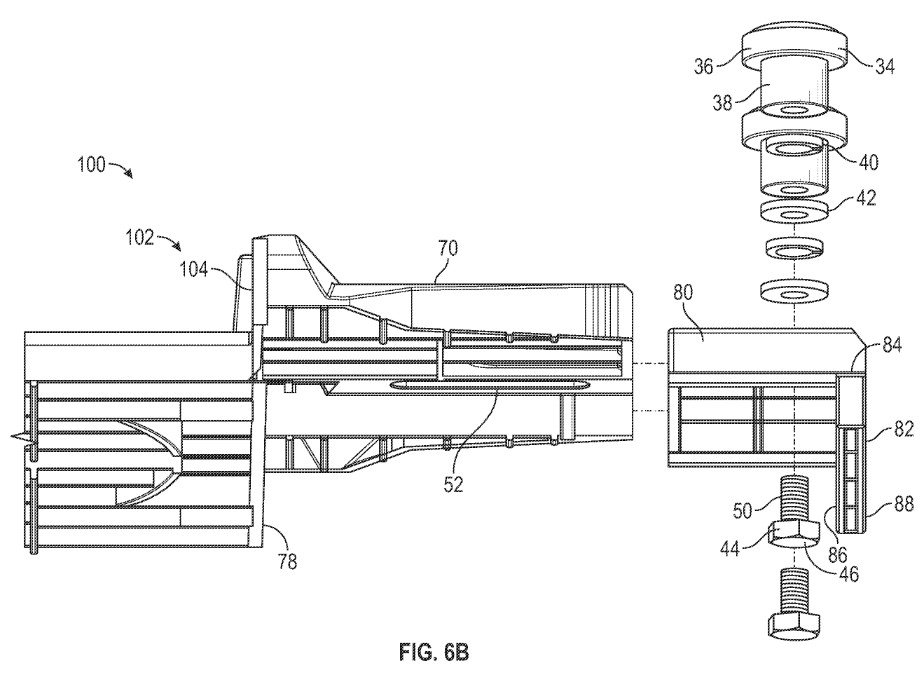

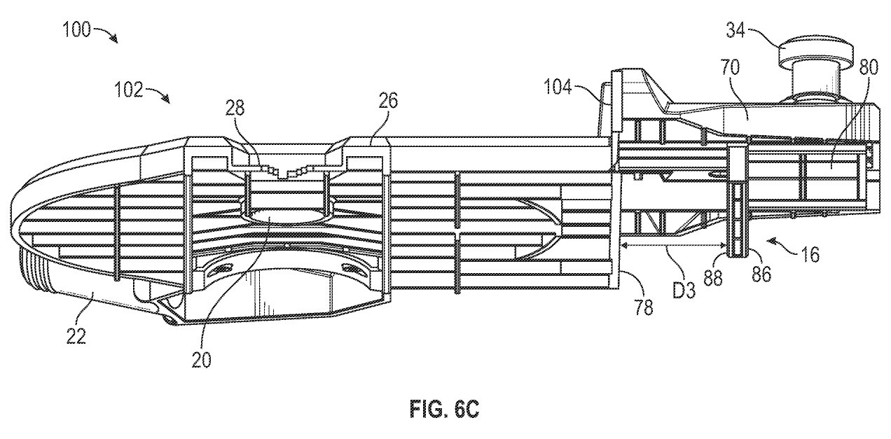

However, as shown in FIGS. 6A-6C, the horizontal surface 80 of movable rail fence 16 is preferably movably secured to the horizontal plate 70 of the jig base 102 via at least two of the adjustment knobs 34. Accordingly, the operation of the movable rail fence 16 relative to the horizontal plate 70 of the jig base 102 is preferably the same as the operation of the movable rail fence 16 relative to the movable adaptor fence 14. Preferably, the jig base 102 also includes the cutting mark 28.

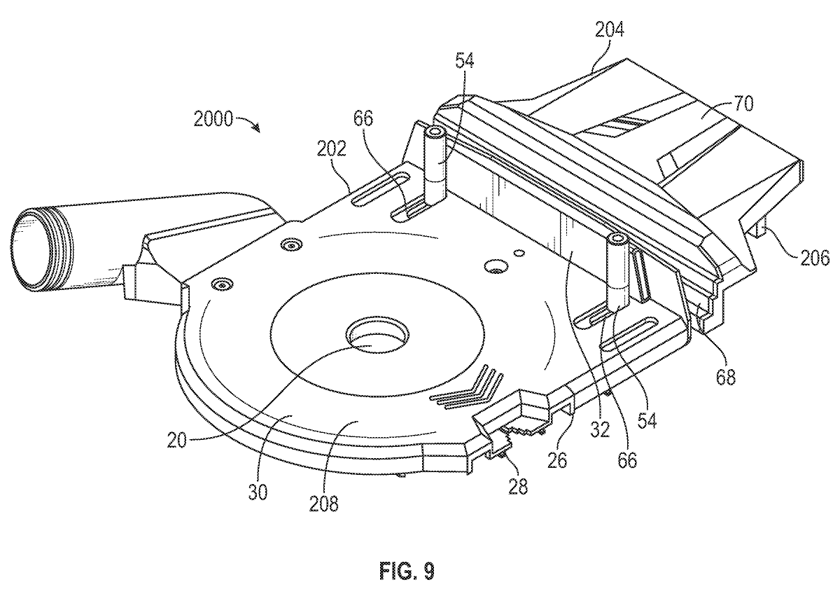

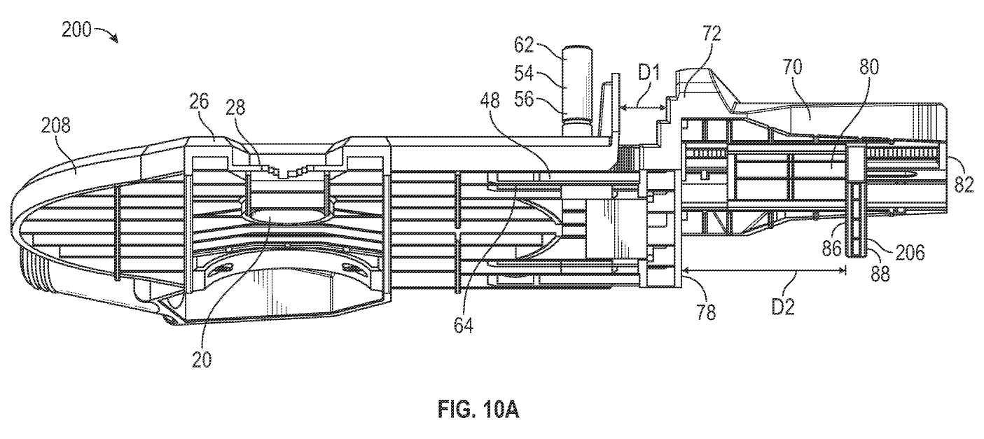

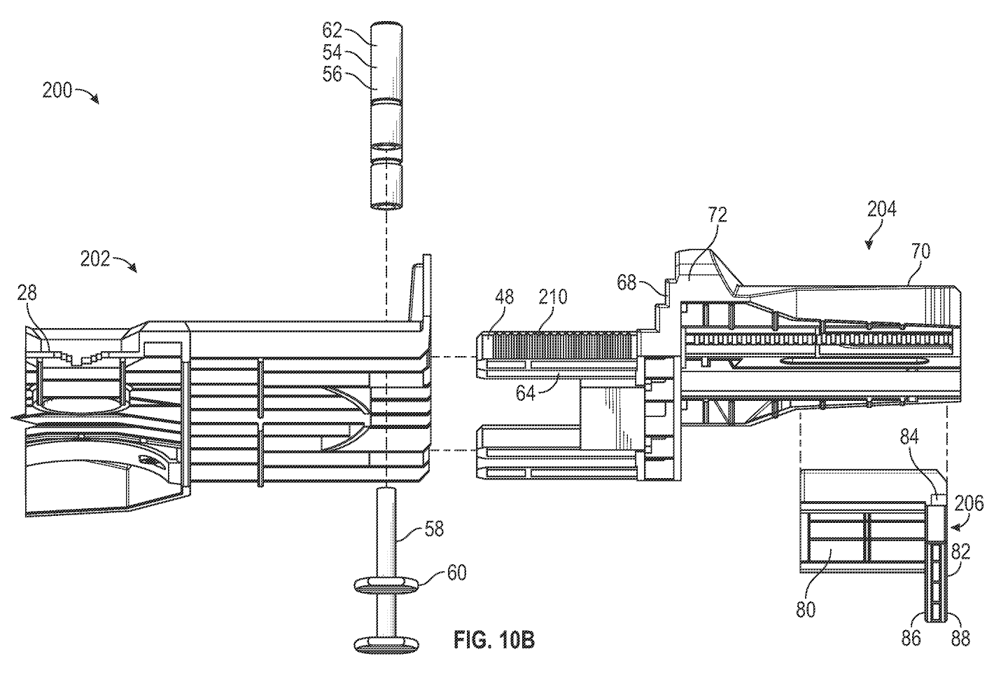

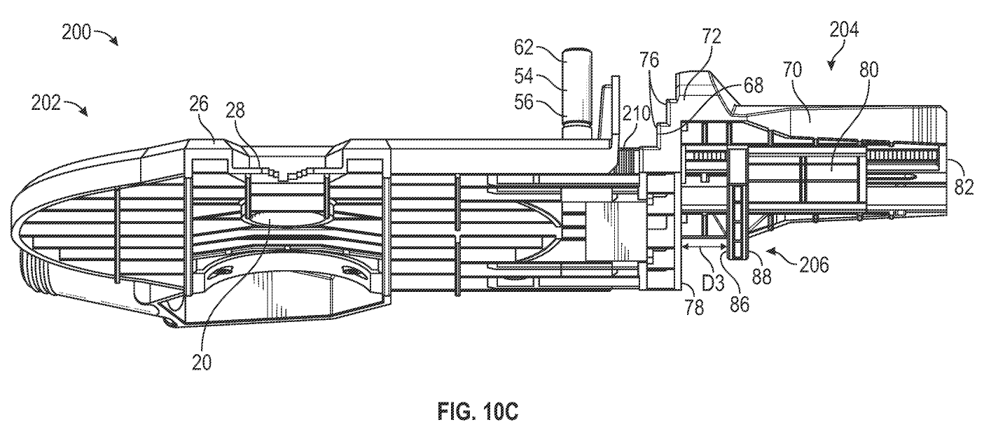

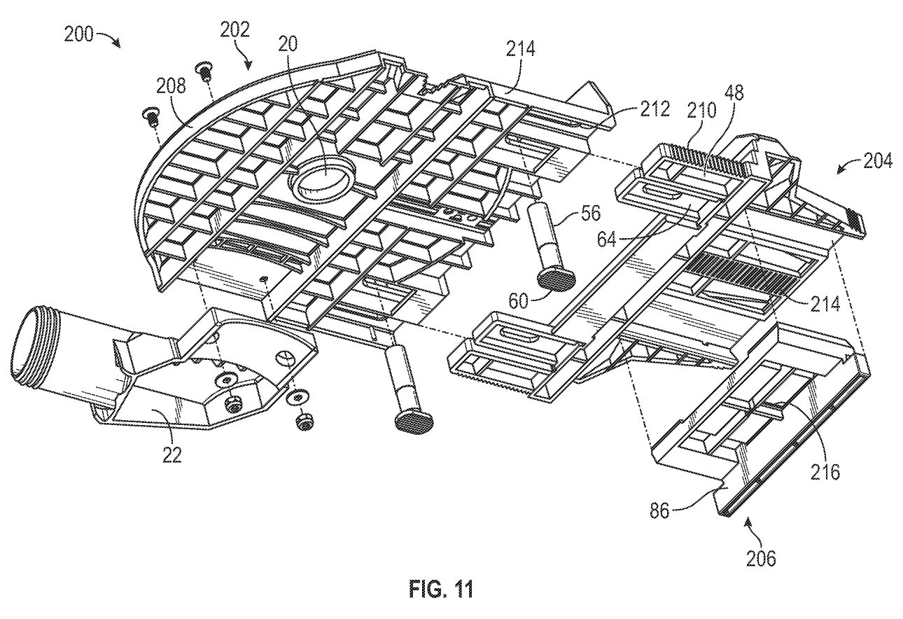

Referring now to FIGS. 9-12F, in which the components are shown schematically and not to scale, a third embodiment of the router jig is generally designated 200. Components which are shared with the first embodiment of the router jig 10 have identical reference numbers. The router jig 200 includes a jig base 202 and a movable adaptor fence 204 which are linearly movable relative to one another. Additionally, the movable adaptor fence 204 is linearly movable relative to a movable rail fence 206. The jig base 202 has a jig base plate 208 which includes the cutting mark 28, as well as the limit setting guide hole 66 which allows adjustment of the relative position of the limit setting knob 54 relative to the adaptor fence 204.

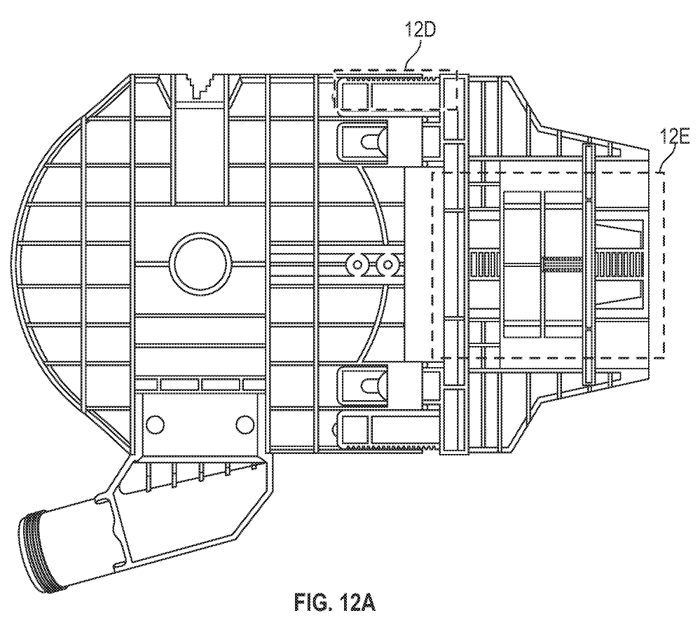

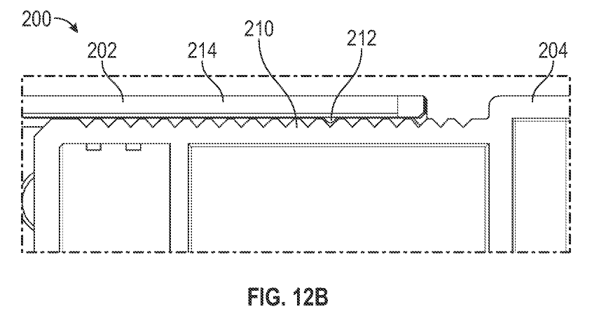

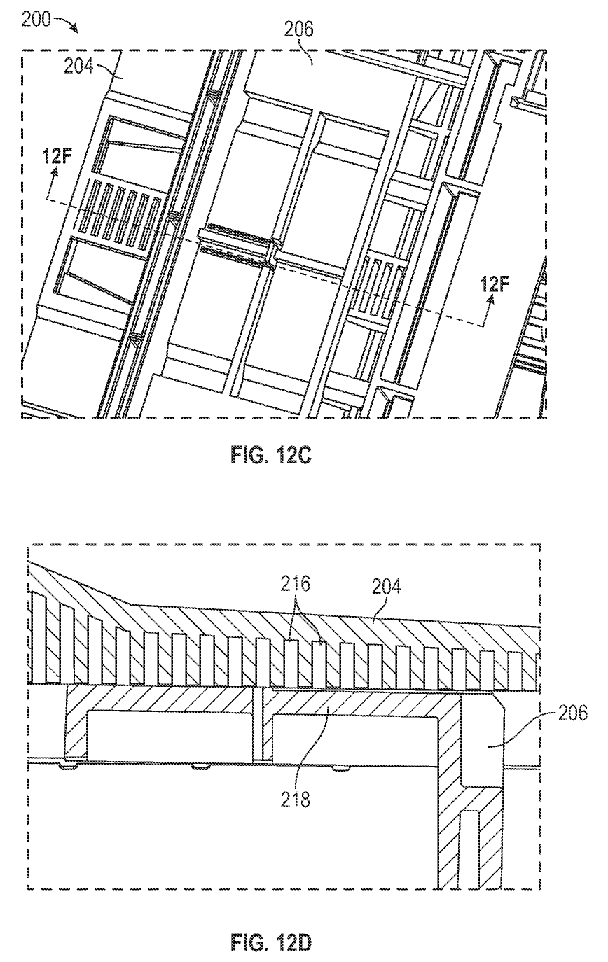

A difference between the first embodiment of the router jig 10 and the third embodiment of the router jig 200, is the mechanism by which the relative position between the jig base 202 and the movable adaptor fence 204 is adjusted. Specifically, referring to FIGS. 12A-12D, the movable adaptor fence 204 includes a plurality of grooves 210 disposed upon the outer leg 48 of the movable adaptor fence, and the jig base plate 208 includes a ridge 212 which engages one of the plurality of grooves. By adjusting which groove 210 is engaged by the ridge 212, the relative position of the movable adaptor fence 204 with respect to the jig base 202 is adjusted. In this way, the adaptor fence 204 has a discrete number of relative positions with the jig base 202. In a preferred embodiment, the plurality of grooves 210 are vertically oriented and are transverse to the jig base plate 208. Further, the ridge 212 is disposed upon a lip 214 which extends from the jig base plate 208, such that ridge is directed toward a center line of the jig base 202 which is transverse to the spacer shield 32.

Similarly, in this preferred embodiment, the adaptor fence 204 includes a plurality of notches 216 disposed below the horizontal plate 70 of the adaptor fence, and the rail fence 206 includes a clip 218 which is disposed upon the horizontal surface 80 of the rail fence. The clip 218 mates with one of the plurality of notches 216, which fixes a relative position of the adaptor fence 204 and the rail fence 206. By adjusting which notch 216 is engaged by the clip 218, the relative position of the movable rail fence 206 with respect to the movable adaptor fence 204 is adjusted. In this way, the rail fence 206 has a discrete number of relative positions with the adaptor fence 204.

While a particular embodiment of the present router jig has been described herein, it will be appreciated by those skilled in the art that changes and modifications may be made thereto without departing from the invention in its broader aspects and as set forth in the following claims.

1. A router jig configured to be secured to a straightedge tool, comprising:
a jig base with a jig base plate having a top surface configured to connect to a router and from which extends a spacer shield;
an adaptor fence, which is removably fastened to said jig base plate, and which is linearly movable with respect to said jig base plate, said adaptor fence including a horizontal plate and a vertical wall, said vertical wall including a stable surface that contacts the straightedge tool and a front face on an opposite side of said vertical wall as said stable surface; and
a rail fence which is removably fastened to said adaptor fence, which is linearly movable with respect to said adaptor fence, and which is rotatable relative to said adaptor fence, said rail fence including a horizontal surface and a vertical guide bar disposed at an end of said horizontal surface, said vertical guide bar including:
a first contacting surface which defines a first distance between said first contacting surface and said stable surface when said rail fence is rotated such that said first contacting surface faces said stable surface; and
a second contacting surface on an opposite side of said vertical guide bar as said first contacting surface, said second contacting surface defining a second distance between said second contacting surface and said stable surface when said rail fence is rotated such that said second contacting surface faces said stable surface.

2. The router jig of claim 1, further comprising:
a cutting mark disposed on a leading edge of said jig base plate, said cutting mark including a center mark, a right side toolpath mark, and a left side toolpath mark, which are aligned with a left edge and a right edge, respectively, of a toolpath generated by the router.

3. The router jig of claim 2, wherein said right side toolpath mark and said left side toolpath mark each include a plurality of steps corresponding to different diameter router bits of the router.

4. The router jig of claim 1, wherein said jig base plate further comprises:
at least one adjustment knob, such that fastening said adjustment knob fixes a relative linear position of said jig base plate and said adaptor fence; and
at least one limit setting knob which sets a limit on the relative linear motion between said jig base plate and said adaptor fence.

5. The router jig of claim 4, wherein said adaptor fence further comprises:
at least one adjustment knob, such that fastening said adjustment knob fixes a relative linear position of said adaptor fence and said rail fence.

6. The router jig of claim 4, wherein said adaptor fence and said rail fence each include at least one guide hole through which said at least one adjustment knob is disposed.

7. The router jig of claim 1, wherein said first distance is greater than said second distance.

8. The router jig of claim 1, wherein said front face of said vertical wall includes a plurality of steps which define different distances between said steps of said front face and said spacer shield.

9. The router jig of claim 1, wherein said adaptor fence includes a plurality of grooves which mate with a corresponding ridge on said jig base plate, such that when said ridge engages one of said plurality of grooves, a relative position of said adaptor fence and said jig base plate is fixed.

10. The router jig of claim 9, wherein said plurality of grooves are disposed on a leg of said adaptor fence and are vertically oriented and said ridge of said jig base plate is disposed upon a lip which extends from said jig base plate, such that said ridge is directed toward a center line of said jig base.

11. The router jig of claim 9, wherein said jig base plate further comprises:
at least one limit setting knob which sets a limit on the relative linear motion between said jig base plate and said adaptor fence.

12. The router jig of claim 1, wherein said adaptor fence includes a plurality of notches which mate with a corresponding clip on said rail fence, such that when said clip engages one of said plurality of notches, a relative position of said adaptor fence and said rail fence is fixed.

13. The router jig of claim 12, wherein said plurality of notices are disposed below said horizontal plate and are vertically oriented, and wherein said clip is disposed upon said horizontal surface of said rail fence.

14. A router jig configured to be secured to a straight edge tool, comprising:
a jig base including:
a jig base plate having a top surface configured to connect to a router;
a vertical plate which extends from said top surface of said jig base plate, said vertical plate including a stable surface that contacts the straight edge tool; and
a horizontal plate which is vertically displaced from said jig base plate and which is connected to said vertical plate; and
a rail fence which is removably fastened to said horizontal plate, which is linearly movable with respect to said jig base, and which is rotatable relative to said horizontal plate, said rail fence including a horizontal surface and a vertical guide bar disposed at an end of said horizontal surface, said vertical guide bar including:
a first contacting surface which defines a first distance between said first contacting surface and said stable surface when said rail fence is rotated such that said first contacting surface faces said stable surface; and
a second contacting surface on an opposite side of said vertical guide bar compared to said first contacting surface, said second contacting surface defining a second distance between said second contacting surface and said stable surface when said rail fence is rotated such that said second contacting surface faces said stable surface.

15. The router jig of claim 14, further comprising:
a cutting mark disposed on a leading edge of said jig base plate, said cutting mark including a center mark, a right side toolpath mark, and a left side toolpath mark, which are aligned with a left edge and a right edge, respectively, of a toolpath generated by the router.

16. The router jig of claim 15, wherein said right side toolpath mark and said left side toolpath mark each include a plurality of steps corresponding to different diameter router bits of the router.

17. The router jig of claim 14, wherein said first distance is greater than said second distance.

18. The router jig of claim 14, wherein said adaptor fence further comprises:
at least one adjustment knob, such that fastening said adjustment knob fixes a relative linear position of said adaptor fence and said rail fence.

19. The router jig of claim 18, wherein said adaptor fence and said rail fence each include at least one guide hole through which said at least one adjustment knob adaptor knob is disposed.
